(19) United States
(12) Patent Application Publication
(10) Pub. No.: US 2024/0056814 A1
(43) Pub. Date: Feb. 15, 2024

(54) SUPPORTING COMPUTER NETWORKING DEVICE CONNECTIONS TO CONTROLLERS USING DIFFERENT CONNECTION PROTOCOLS

(71) Applicant: ARRIS Enterprises LLC, Suwanee, GA (US)

(72) Inventors: Renjith Kumar Ponnappan, Fremont, CA (US); Sanjeev Chhabria, Fremont, CA (US); Cheng-Ming Chien, New Taipei City (TW); Han-Chien Huang, San Jose, CA (US)

(21) Appl. No.: 18/446,721

(22) Filed: Aug. 9, 2023

Related U.S. Application Data
(60) Provisional application No. 63/396,654, filed on Aug. 10, 2022.

(51) Int. Cl. H04W 12/088; H04W 12/48

(52) U.S. Cl. CPC H04W 12/088; H04W 12/48

(57) ABSTRACT

Computer networking devices and controllers thereof may communicate via a secure tunnel. Aspects of the present disclosure provide methods, systems, and devices that facilitate establishment of such tunnels. For example, a method may include: generating, by a computer networking device, a tunneling capabilities message indicating a plurality of different tunnel types supported by the computer networking device; transmitting the tunneling capabilities message to a controller; receiving, from the controller, a tunneling selection response message indicating one of the plurality of different tunnel types; requesting, by the computer networking device, establishment of a tunnel of the one tunnel type indicated by the tunneling selection response message; and establishing the tunnel of the one tunnel type between the computer networking device and the controller.

The present application claims the benefit of priority to U.S. Provisional Application No. 63/396,654, filed on Aug. 10, 2023, and the entire contents of the above-identified application are incorporated by reference as if set forth herein.

### TECHNICAL FIELD

The present disclosure relates to configuring computer networking devices, and in particular relates to devices, systems, and methods for connecting computer networking devices to controllers using different connection protocols.

### BACKGROUND

Computer networking devices, such as switches, routers and/or access points, typically require configuration and management in order to be useful. For example, a wireless access point may need to be provided with networking details, such as a broadcast network name, Dynamic Host Configuration Protocol (DHCP) server information, security information (e.g., encryption method, passphrase information), authentication, authorization, and accounting (AAA) details, and/or the like.

In some computer networks, particularly smaller networks with a limited number of computer networking devices, networking details may be provided to each computer networking device via a device-specific user interface (such as a graphical user interface or text-based command line interface) that is accessible via a web browser, command prompt, or the like. In some computer networks, such as enterprise networks where larger numbers of computer networking devices are deployed, one or more controllers that manage the access points, switches, etc. may be provided. The controller may be one of the computer networking devices (e.g., an access point that also acts as a controller for the network), a different standalone device, or a software application available via an external network (e.g., a cloud-based controller). The controller may control various aspects of the operation of the computer networking devices, and by extension, the computer network. For example, the controller may provide configuration management, user authentication, events/alarms reports, statistics reports, and/or monitoring of functions.

A controller may communicate with each of its controlled computer networking devices using one or more of a variety of techniques and protocols. For example, the controller and the computer networking devices may communicate commands and information via Simple Network Management Protocol (SNMP)-based messages, Syslog messages, Telnet sessions, command line interface (CLI) sessions, HyperText Transfer Protocol-based messages (e.g., a Representational State Transfer (REST) architecture) and/or an application programming interface (API) that uses a protocol, such as Network Configuration Protocol (NETCONF), RESTConf, LightWeight Access Point Protocol (LWAPP), and/or Control and Provisioning of Wireless Access Points (CAPWAP). Typically, a vendor or manufacturer of a vendor of the computer networking device and the controller selects the specific techniques and protocols that are supported by the computer networking device and the controller for communication therebetween.

### SUMMARY

According to some embodiments of the present inventive concepts, a method is provided. The method may include: generating, by a computer networking device, a tunneling capabilities message indicating a plurality of different tunnel types supported by the computer networking device; transmitting the tunneling capabilities message to a controller; receiving, from the controller, a tunneling selection response message indicating one of the plurality of different tunnel types; requesting, by the computer networking device, establishment of a tunnel of the one tunnel type indicated by the tunneling selection response message; and establishing the tunnel of the one tunnel type between the computer networking device and the controller.

According to some embodiments of the present inventive concepts, a method is provided. The method may include receiving, by a controller, a tunneling capabilities message indicating a plurality of tunnel types that are supported by a computer networking device; selecting, by the controller, one of the tunnel types from the plurality of tunnel types indicated by the tunneling capabilities message; transmitting a tunneling selection response message to the computer networking device indicating the selected tunnel type; receiving, by the controller, a request to establish a tunnel of the selected tunnel type; and establishing a tunnel of the selected tunnel type between the computer networking device and the controller.

According to some embodiments of the present inventive concepts, a method is provided. The method may include generating, by a computer networking device, a tunneling capabilities message indicating a plurality of different tunnel types supported by the computer networking device; transmitting the tunneling capabilities message to a controller; identifying that a tunneling selection response message from the controller has not been received after a predetermined time interval has elapsed; requesting, by the computer networking device, establishment of a tunnel of a default tunnel type of the plurality of different tunnel types; and establishing the tunnel of the default tunnel type between the computer networking device and the controller.

The present disclosure is not limited to the embodiments described above, and other embodiments of the inventive concepts will be both be described herein and will be apparent to those skilled in the art.

### BRIEF DESCRIPTION OF THE FIGURES

FIG. 1 is a block diagram illustrating electronic devices and computer networking devices in a network according to some embodiments of the present disclosure.

FIGS. 2A-D are communication diagrams illustrating aspects related to establishing tunneling sessions between computer networking devices and controllers.

FIG. 3 is a communication diagram illustrating providing a tunneling capabilities message from a computer networking device to a controller according to some embodiments of the present disclosure.

FIGS. 4A-B are communication diagrams illustrating examples of generating and communicating tunneling capabilities messages and processing responses indicating a selected tunnel type, according to some embodiments of the present disclosure. FIG. 4C is a communication diagram illustrating an example of generating and communicating a tunneling capabilities messages and selecting a default tunnel type when no response is received, according to some embodiments of the present disclosure.

FIG. 5A is a block diagram illustrating example fields of a tunneling capabilities message, and FIGS. 5B and 5C are block diagrams illustrating example fields of example tunneling selection response messages, according to some embodiments of the present disclosure.

FIGS. 6A and 6B are flow diagrams of generating and transmitting a tunneling capabilities message and establishing a tunnel based on the response (or lack thereof) to the tunneling capabilities message, according to some embodiments of the present disclosure.

FIG. 7 is a flow diagram of receiving a tunneling capabilities message, selecting a tunneling type, generating and transmitting a response indicating the selected tunneling type, and establishing a tunnel based on selected tunneling type, according to some embodiments of the present disclosure.

FIG. 8 is a block diagram illustrating an example of an electronic device according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

A computer networking device that is to be managed by a controller first needs to form a connection with the controller by locating or discovering the controller on a network. In some topologies, a network administrator may provide the controller network address (e.g., Internet Protocol (IP) address) to the computer networking device via a user interface, such as a web application or command line interface. Herein, the discussion will primarily use a switch as an example computer networking device, and it will be appreciated that the techniques disclosed herein may be used with a wide variety of computer networking devices, such as access points, routers, data planes, etc. In large-scale deployments, a switch may be configured to discover its controller automatically or in an automated fashion, e.g., with minimal involvement from a human network administrator. For example, a switch may automatically discover the network address of a controller in the same subnet in the network, and the switch may then be automatically configured by its controller. A variety of techniques may be used to advertise the network address of a controller to the switch.

Using the discovered network address of the controller, the switch or other computer networking device may contact the controller with a request to establish a secure tunnel therebetween. This secure tunnel enables commands and information to be exchanged between the computer networking device and the controller in a more secure manner. The secure tunnel may be established according to one a variety of different tunnel protocols.

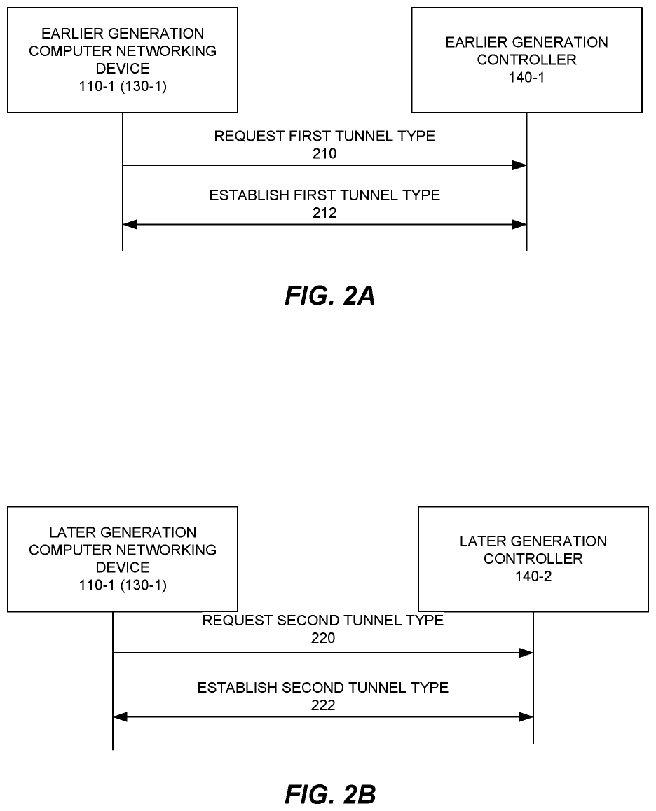

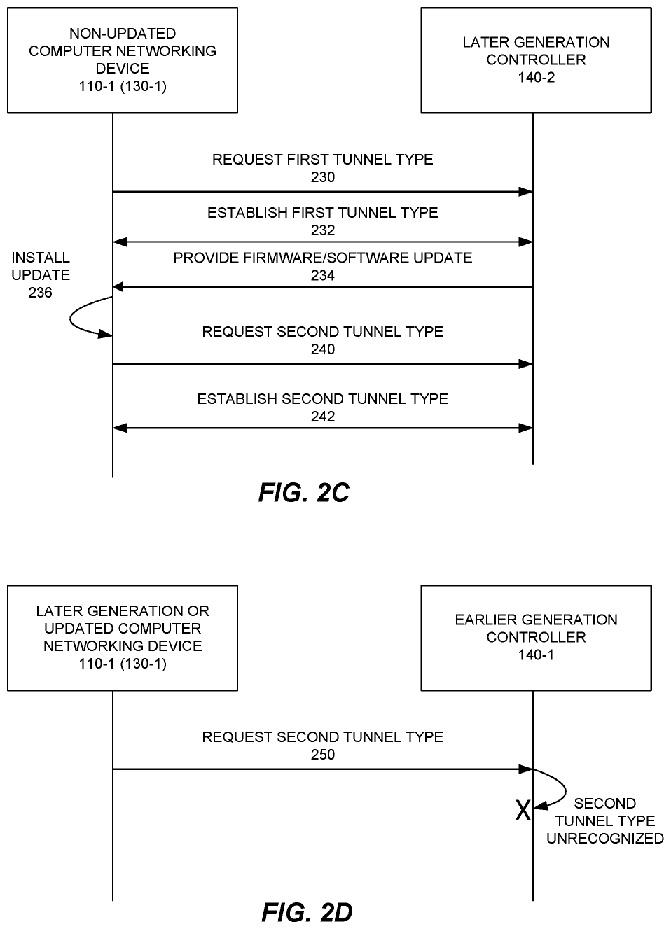

In some instances, and with reference to FIGS. 2A-D below, changes to software run by the computer networking device, such as software and/or firmware updates to the computer networking device, may result in the computer network device requesting that a tunnel be established according to a protocol that is unsupported by the controller. For example, the customer or operator of the computer networking device may be using a later version of the controller (that does support the requested tunnel protocol), but then decide to downgrade or rollback the operating version of the controller to an earlier version (that does not support the requested protocol). For example, the customer may be using only a temporary license to or trial version of the later version of the controller. As another example, the customer may have a heterogeneous set of controllers in which an earlier version on-premise controller is acting as a fallback solution in case a cloud-based later generation controller fails or is unreachable. Therefore, in some situations, the computer networking device may be unable to establish a tunnel with the controller that is to manage the computer networking device, and may be unable to complete a configuration process.

Pursuant to embodiments of the present disclosure, the computer networking devices and may be configured to generate and transmit a tunneling capabilities message to the controller after discovery thereof, and prior to the establishing of a tunnel between the computer networking device and the controller. The tunneling capabilities message may include one or more tunnel types (or tunnel protocols) supported by the computer networking device. In some embodiments, the computer networking device may be configured to use two or more different tunnel types (e.g., a first tunnel type according to a first tunnel protocol and a second tunnel type according to a second tunnel protocol). Additionally, the controller may be configured to receive the tunneling capabilities message and select one of the tunnel types that is supported by the controller, and then generate and transmit a tunneling selection response message to the computer networking device that includes the selected tunnel type. Based on the response message, the computer networking device may request to establish a tunnel with the controller according to the selected tunnel type.

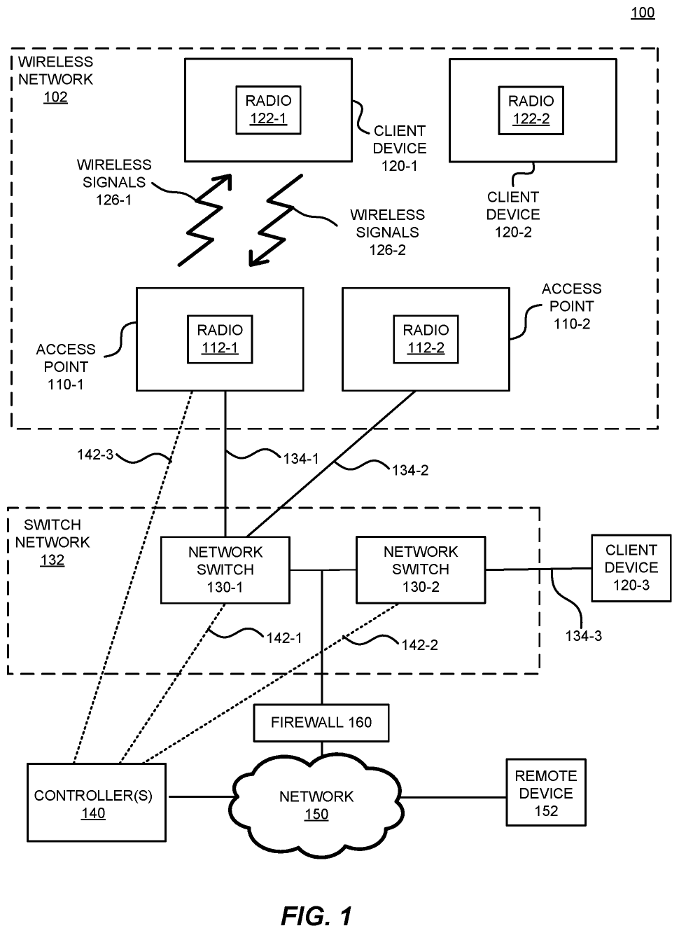

FIG. 1 is a block diagram illustrating electronic devices and computer networking devices in a network 100 according to some embodiments of the present disclosure. In the network 100, one or more access points 110 may communicate with client devices 120 in a wireless network 102, which may be a wireless local area network (WLAN). The access points 110 may be serviced by a switch network 132 that includes one or more network switches and/or routers 130, which may facilitate access to a network (e.g., an external network) 150. The access points 110 and network switches and/or routers may be referred to herein collectively as computer networking devices 110/130. The network 100 may also include other computer networking devices (not shown) such as data planes or the like.

The access points 110 may communicate using wireless and/or wired communication (such as by using Ethernet or a communication protocol that is compatible with Ethernet) with the client devices 120. Herein, wireless communication may include communication of packets or frames in accordance with a wireless communication protocol, such as an Institute of Electrical and Electronics Engineers (IEEE) 802.11 standard (sometimes referred to as ‘WiFi’. In the discussion that follows, WiFi is used as an illustrative example. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Other wireless interfaces and/or protocols may be used, such as Bluetooth, and unless stated otherwise, the present disclosure is not limited to a particular wireless communication standard, interface, or protocol.

In some embodiments, the access points 110 may include physical access points and/or virtual access points that are implemented in software in an environment of an electronic device or a computer. In some embodiments, the access points 110 may communicate with each other via wired or wireless connections (e.g., via the switch network 132 or via wireless signals 126). The wired and/or wireless communication among access points 110 in wireless network 102 may occur via a network (such as an intra-net, a mesh network, point-to-point connections and/or the Internet) and may use a network communication protocol, such as Ethernet. In some embodiments, the access points 110 may be arranged in a mesh configuration, such as where a direct wired or wireless connection between an access point 110 and a network switch 130 of the switch network 132 is absent, and the access point 110 instead communicates indirectly with the switch network 132 and/or the network 150 via an intermediate access point 110.

As can be seen in FIG. 1, wireless signals 126-1 (represented by a jagged line) are transmitted from a radio 112-1 in access point 110-1. These wireless signals may be received by radio 122-1 in a client device 120-1. Wireless signals 126-2 (represented by a jagged line) are transmitted from the radio 122-1 in the client device 120-1. These wireless signals may be received by the radio 112-1 in the access point 110-1. Each of the radios 112 and 122 may be configured to generate and/or receive radio frequency signals in one or more wireless communication frequency bands (e.g., the 2.4 GHz frequency band, the 5 GHz frequency band, the 6 GHz frequency band, and so on). Although only one radio 112/122 is shown in each of the access points 110 and client devices 120, it may be understood that in some embodiments multiple radios 112/122 may be present, each configured to generate and/or receive signals in different frequency bands.

Each of the client devices 120 may be, for example, any network-capable electronic device, including (as non-limiting examples) a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device. As seen in FIG. 1, some client devices 120 (e.g., client device 120-3) may not be part of the wireless network 102, and may instead be directly coupled with a network switch 130 of the switch network 132.

The switch network 132 may include one or more network switches and/or routers 130. In some embodiments, the one or more network switches and/or routers 130 may include a stack of multiple switches or routers (which are sometimes referred to as ‘stacking units’). As an example, a network switch 130-1 may include a number of communication interfaces or ports (not shown) in communication with one or more electronic devices. During operation, a first of the communication interfaces may receive a packet or other data container from a first electronic device (e.g., a client device 120, an access point 110, another networking switch 130). The packet may then be processed and forwarded to a second port associated with a second electronic device. The network switch and/or router 130 may be a layer-2 or layer-3 network switch or router. The switch network 132, and the network switches 130 thereof, may be coupled to access points 110 of the wireless network 102 via wired links 134.

The controller 140 may be configured to perform configuration operations and/or management operations that control functionality of the computer networking devices 110/130. For example, the controller 140 may define flow definitions comprising packet processing rules and corresponding actions and promulgate these rules to the network switches 130 of the switch network 132. As another example, the controller 140 may manage the access points 110, for example by providing various configuration information, controlling settings, routing information, authorization/authentication information, or the like. The controller 140 may communicate with the access point 110 and/or network switches 130 via one or more logical links 142, which in some embodiments may at least partially overlap the wired links 134. The controller 140 may be configured to offer a single user interface accessible via a web browser, command prompt, or the like, via which control commands may be entered.

In some embodiments, the controller 140 may be connected via physical links with one or more of the access points 110 or the network switches 130 (and may be part of the switch network 132). In some embodiments, the controller 140 may be one of the network switches 130. In some embodiments, the controller 140 may be a cloud-based controller 140 that may be operating at a location relatively remote from the switch network 132 and the network switches 130 thereof. The cloud-based controller 140 may communicate with the network switches 130 via a network 150. The controller 140 may be configured to receive commands from a remote device 152, which in some embodiments may be a laptop computer or other device similar to a client device 120 that is operated by a network administrator to perform configuration of the network 100. In some embodiments, more than one controller 140 may be present in the network 100. In some embodiments, the network switches 130 may be at locations relatively remote from one another, and may communicate with each other via a network, such as the network 150.

The network 150 may be a layer-2 or layer-3 network, and may include one or more local area networks (LANs), campus area networks (CANs), wide area networks (WANs), metropolitan area networks (MANs), and/or the Internet. The network 150 may be separated from the switch network 132 by a firewall 160, which may monitor network traffic that is incoming to and outgoing from the switch network 132 and decide whether to permit or prohibit various traffic based on one or more security rules.

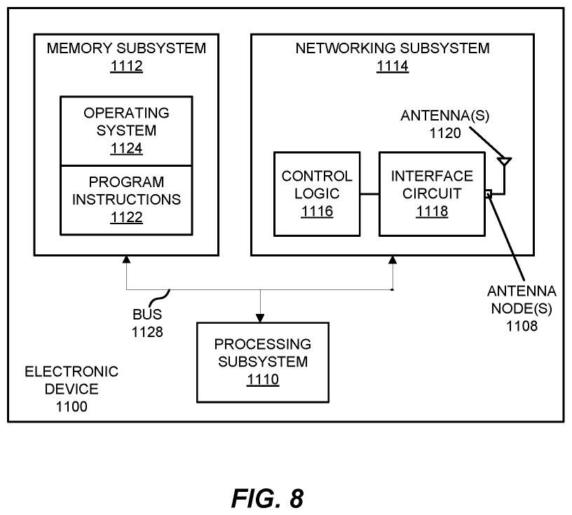

As described further below with reference to FIG. 8, the one or more computer networking devices 110/130 (e.g., access points 110, network switches 130), client devices 120, controller 140, firewall 160, and/or remote device 152 may include subsystems, such as a networking subsystem, a memory subsystem and a processor subsystem. More generally, the access points 110, network switches 130, and/or client devices 120 can include (or can be included within) any electronic devices with the networking subsystems that enable the access points 110, network switches 130, and/or client devices 120 to communicate with each other using wireless and/or wired communication.

As discussed above, the one or more computer networking devices 110/130 may be configured to communicate with a controller 140. In some embodiments, this communication may be performed via a tunnel session that is established using a tunneling protocol. A tunneling protocol allows for the movement of data in a relatively secure manner, usually by encapsulating the data traffic in a packet or other container and/or encrypting the data. The one or more computer networking devices 110/130 may be configured to communicate with a controller 140 For example, FIG. 2A is a flow diagram illustrating aspects related to establishing tunneling sessions between computer networking devices and controllers.

Prior to the communications illustrated in FIG. 2A, a first computer networking device, such as a network switch 130-1 or access point 110-1 may discover a controller 140-1 that is part of a network 100. In some embodiments, the first computer networking device 110-1/130-1 may automatically discover the network address of a controller in the same subnet in the network. A variety of techniques may be used to advertise the network address of a controller 140-1 to the first computer networking device 110-1/130-1. For example, the address of the controller 140-1 may be advertised by configuring the network, such as by registering the controller with a domain name server (DNS) or configuring the Dynamic Host Control Protocol (DHCP) server using a setting or configuration, such as DHCP option 43. In some embodiments, a network address of the controller 140-1 may be registered with a device registration service (sometimes called a device registrar), and the first computer networking device 110-1/130-1 may contact the device registration service and provide a unique identifier thereof (e.g., a serial number or other unique identifier) to the device registration service. The device registration service may then return the network address of the previously-registered controller 140-1 to the first computer networking device 110-1/130-1.

Using the discovered network address of the controller 140-1, the first computer networking device 110-1/130-1 may contact the controller 140-1 with a request to establish a tunnel 142 (communication 210 of FIG. 2A). The first computer networking device 110-1/130-1 and the controller 140-1 may then exchange messages to establish the requested tunnel (communication 212 of FIG. 2A). The requested tunnel 142 may extend through the firewall 160.

Software and/or firmware on the first computer networking device 110-1/130-1 and the controller 140 may be configured by the vendor or manufacturer of the first computer networking device 110-1/130-1 to use a first tunneling protocol for communication therebetween. For example, a secure shell (SSH) tunnel protocol may be used. Therefore, the communication 210 of FIG. 2A may be considered to be a request to establish a tunnel according to this first tunnel protocol, which may be referred to herein as a first tunnel type. The tunnel established via communication 212 of FIG. 2A may be the first tunnel type.

The vendor or manufacturer of the one or more computer networking devices 110/130 and the controller 140-1 may release new products (e.g., updated versions or generations of computer networking devices 110/130 and/or controllers 140) which run firmware or software in which the tunneling protocol is upgraded or changed. This change may, or may not be, backwards compatible. For example, an updated version of the SSH tunneling protocol may be used, or the vendor or manufacturer may decide to use a different tunneling protocol, such as Websocket. The vendor or manufacturer may decide to change the tunneling protocol for one or more of a variety reasons, including to improve security, increase software development speed (e.g., increase a rate of deployment of software releases), remove scaling bottlenecks, underlying architecture changes, customer-support reasons, and so on.

FIG. 2B is a flow diagram illustrating aspects related to establishing tunneling sessions between later-generation computer networking devices and later-generation controllers. Using a discovered network address of the controller 140-2, an updated computer networking device 110-1/130-1 may contact the controller 140-2 with a request to establish a tunnel (communication 220 of FIG. 2B). The first computer networking device 110-1/130-1 and the controller 140-2 may then exchange messages to establish the requested tunnel (communication 222 of FIG. 2B). Software and/or firmware on the later-generation computer networking devices 110-1/130-1 and the later-generation controller 140-2 may be configured by the vendor or manufacturer thereof to use a second tunneling protocol for communication therebetween. For example, a Websocket tunnel protocol may be used. Therefore, the communication 220 of FIG. 2B may be a request to establish a tunnel according to this second tunnel protocol, which may be referred to herein as a second tunnel type. The tunnel established via communication 222 of FIG. 2B may be a tunnel according to the second tunnel type.

Some customers may desire to upgrade their computer networking devices 110/130 and/or controllers 140 to utilize new or improved functionality. One scenario may be upgrading or changing the controller 140-1 while retaining the hardware of the one or more computer networking devices 110/130, since replacing the hardware of the one or more computer networking devices 110/130 may be disruptive or cost-prohibitive. For example, the customer may desire to move from an earlier generation on-premise or cloud-based controller 140-1 to a later generation cloud-based controller 140-2. However, the later generation controller may expect to utilize the second tunnel type (e.g., Websocket) rather than the first tunnel type (e.g., SSH) for communication with the one or more computer networking devices 110/130. To address this, the manufacturer or vendor may release software or firmware updates for earlier-generation computer networking devices 110/130. Upon installation of the software or firmware updates, the one or more computer networking devices 110/130 may be configured to use the second tunnel type instead of the first tunnel type. Although such software or firmware updates may be installed by customers on a device-by-device basis (e.g., manually installing the update on each computer networking device 110/130), in some embodiments, the controller 140 may provide the update during an initialization process. FIG. 2C is a flow diagram illustrating aspects related to establishing tunneling sessions between a non-updated earlier-generation computer networking devices 110-1/130-1 and a later-generation controller 140-2.

First, and similar to the communications 210 and 212 of FIG. 2A, the earlier-generation computer networking device 110-1/130-1 may request that a tunnel according to the first tunnel type be established (communication 230 of FIG. 2C), and the later generation controller 140-2 may receive the request and, in coordination with the computer networking device 110-1/130-1, establish a tunnel according to the first tunnel type (communication 232 of FIG. 2C). In some embodiments, the later generation controller 140-2 may include a backwards compatibility module configured to receive the request according to the first tunnel type. The backwards compatibility module may only have limited functionality. Upon detecting that the tunnel according to the first tunnel type has been established, the controller 140-2 (or the backwards compatibility module thereof) may communicate a firmware and/or software update to the computer networking device 110-1/130-1 via the tunnel according to the first tunnel type (communication 234 of FIG. 2C). The computer networking device 110-1/130-1 may receive the firmware and/or software update and may install the same (communication 236 of FIG. 2C). The installation of the firmware and/or software update may reconfigure the computer networking device 110-1/130-1 to use the second tunnel type instead of the first tunnel type.

After installation of the firmware and/or software update, the now updated computer networking device 110-1/130-1 may use a discovered network address of the controller 140-2 and contact the controller 140-2 with a request to establish a tunnel according to the second tunnel type (communication 240 of FIG. 2C, which may be similar to the communication 220 of FIG. 2B). The updated computer networking device 110-1/130-1 and the controller 140-2 may then exchange messages to establish the requested tunnel according to the second tunnel type (communication 242 of FIG. 2D).

The upgrade mechanism of FIG. 2C permits a customer to upgrade or change a network in a somewhat piecemeal fashion, enabling updating, upgrading, or changing of the controller 140 of the network to a later version or generation without necessarily having to install new access points 110 and/or networking switches 130. Separately, the upgrade mechanism of FIG. 2C is desirable for the vendor or manufacturer of the controller 140 and the one or more computer networking devices 110/130, in that it enables the updating or upgrading of the one or more computer networking devices 110/130 as needed (e.g., when connecting to a later generation controller).

Although the upgrade mechanism of FIG. 2C has benefits, there are also some drawbacks. In some instances, the customer or operator of the one or more computer networking devices 110/130 and the controllers 140 may decide to downgrade or rollback the operating version of the controller 140. For example, the customer may be using only a temporary license to or trial version of the later generation of the controller 140, and the customer may elect not to continue with using the later generation of the controller 140. As another example, the customer may use an on-premise earlier generation controller 140-1 as a fallback solution in case a cloud-based later generation controller 140-2 fails or is unreachable. FIG. 2D is a flow diagram illustrating a potential problem in establishing tunneling sessions between later-generation (updated) computer networking devices and earlier-generation controllers. As seen, the updated or later generation computer networking device 110-1/130-1 may use a discovered network address of the controller 140-2 and contact the controller 140-2 with a request to establish a tunnel according to the second tunnel type (communication 250 of FIG. 2D). However, as the earlier generation controller 140-1 is only configured to receive requests and establish tunnels according to the first tunnel type, the process may fail, and the updated or later generation computer networking device 110-1/130-1 may not connect to the controller 140-1.

Pursuant to embodiments of the present disclosure, the computer networking devices 110 and 130 may be configured to generate and transmit a tunneling capabilities message to the controller 140 after discovery thereof (and prior to the establishing of a tunnel 142 between the computer networking device 110/130 and the controller 140). The tunneling capabilities message may include one or more tunnel types (or tunnel protocols) supported by the computer networking device 110/130. In some embodiments, updated or later generation computer networking devices 110 and 130 may be configured to use either the second tunnel type or the first tunnel type. Additionally, the controller 140 may be configured to receive the tunneling capabilities message and select one of the tunnel types that is supported by the controller, and then generate and transmit a tunneling selection response message to the computer networking device that includes the selected tunnel type. Based on the response message, the computer networking device may request to establish a tunnel with the controller according to the selected tunnel type.

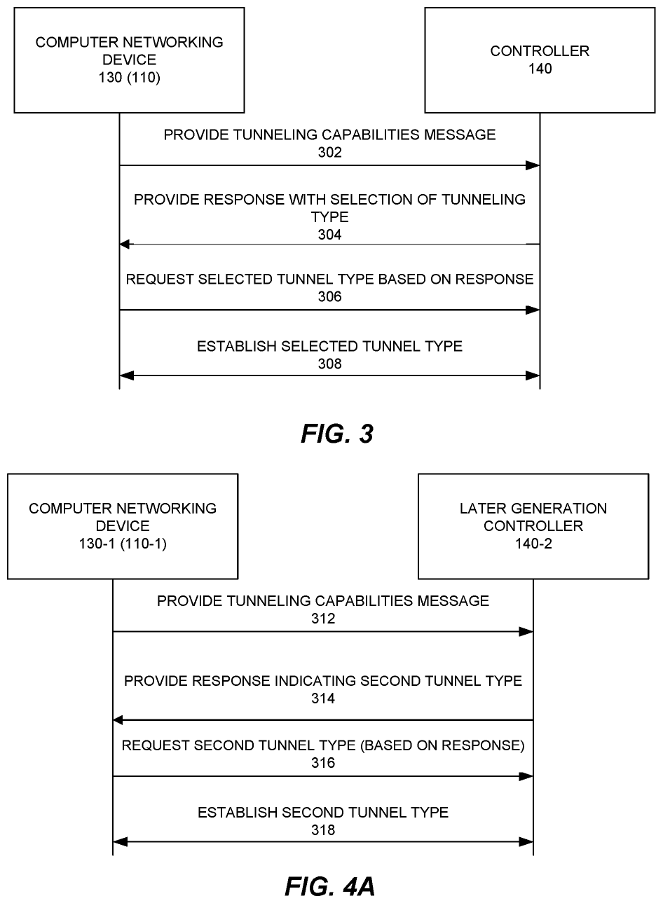

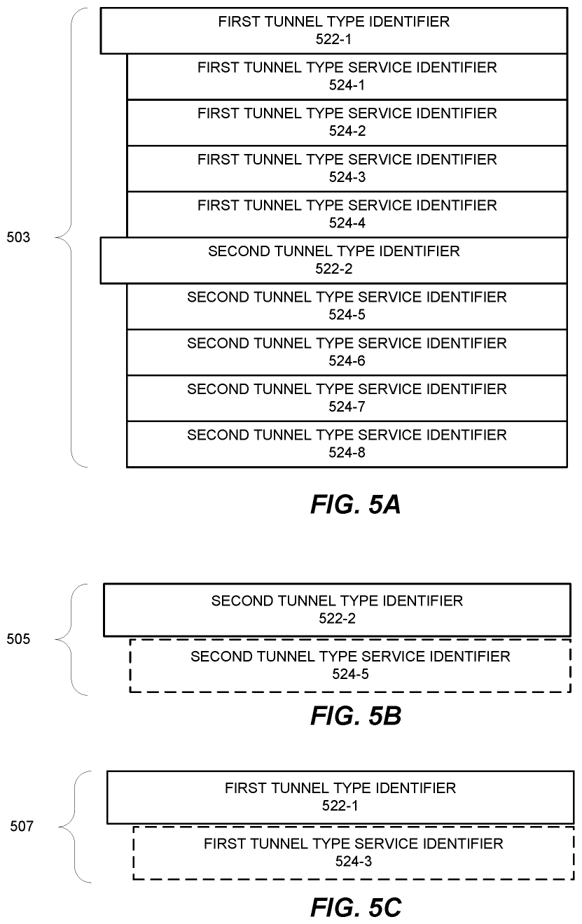

FIG. 3 is a communication diagram illustrating providing a tunneling capabilities message from a computer networking device to a controller according to some embodiments of the present disclosure. In FIG. 3, a computer networking device 110/130 may generate and transmit a tunneling capabilities message to the controller 140 after discovery thereof (communication 302 of FIG. 3). With reference to FIG. 5A, the tunneling capabilities message communicated to the controller 140 may include one or more tunnel types (or tunnel protocols) supported by the computer networking device 110/130.

The controller 140 may receive the tunneling capabilities message and select one of the tunnel types that is supported by the controller 140, and then the controller 140 may generate and transmit to the computer networking device 110/130 a tunneling selection response message indicated the selected tunnel type (communication 304 of FIG. 3). The computer networking device 110/130 may receive the tunneling selection response message, identify the tunnel type selected by the controller 140, and then generate and transmit a request to the controller 140 to establish a tunnel according to the selected tunnel type (communication 306). With reference to FIGS. 5B and 5C, the tunneling selection response message communicated to the controller 140 may include a single tunnel type (or tunnel protocol) that is supported by the controller 140.

The communication 306 of FIG. 3C may be similar to the communications 210 of FIG. 2A and 220 of FIG. 2B. The controller 140 may receive the request to establish the tunnel and, in coordination with the computer networking device 110/130, establish a tunnel 142 according to the selected (and supported) tunnel type (communication 308 of FIG. 3). The requested tunnel 142 may extend through a firewall 160.

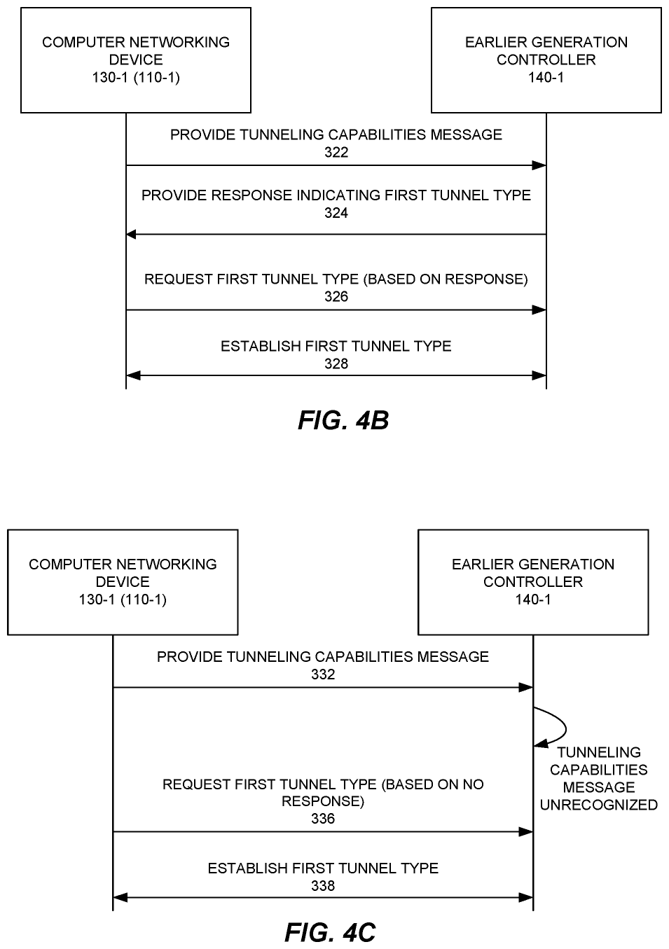

FIGS. 4A-B are communication diagrams illustrating examples of generating and communicating tunneling capabilities messages and processing responses indicating a selected tunnel type, according to some embodiments of the present disclosure.

In FIG. 4A, a computer networking device 110-1/130-1 may generate and transmit a tunneling capabilities message to the controller 140 (which may be a later generation controller 140-2) after discovery of the later generation controller 140-2 (communication 312 of FIG. 4A). The tunneling capabilities message may include a first tunnel type indicator and a second tunnel type indicator. In other words, the computer networking device 110-1/130-1 may support establishing and communicating via a plurality of different tunnel types. The later generation controller 140-2 may receive the tunneling capabilities message and select one of the tunnel types that is supported by the later generation controller 140-2 for full communication, and then the later generation controller 140-2 may generate and transmit to the computer networking device 110-1/130-1 a tunneling selection response message indicated the selected tunnel type (communication 314 of FIG. 4A). For example, the later generation controller 140-2 may support the second tunnel type for full communication, and the later generation controller 140-2 may select the second tunnel type on this basis. The computer networking device 110-1/130-1 may receive the tunneling selection response message, identify the second tunnel type selected by the later generation controller 140-2, and then generate and transmit a request to the later generation controller 140-2 to establish a tunnel according to the second tunnel type (communication 316 of FIG. 4A). The later generation controller 140-2 and the computer networking device 110-1/130-1, in coordination with each other, may establish a tunnel according to the second tunnel type (communication 318 of FIG. 4A).

In some embodiments, and with reference to FIG. 2C, the controller 140-2 may also support establishing and communicating via a tunnel according to first tunnel type, albeit on a limited basis or for limited communication, such as to establish a tunnel for the purposes of upgrading computer networking devices 110/130. Therefore, although the controller 140-2 may therefore support the establishing and communicating via a tunnel according to first tunnel type, the controller 140-2 may be configured to select the second tunnel type, on the basis that the second tunnel type is supported by the later generation controller 140-2 for full communication with the computer networking devices 110/130. In other words, in some embodiments, a controller 140 may be configured to select a tunnel type from a plurality of tunnel types supported by the controller on the basis that the selected tunnel type is intended to be used for full or normal communication with the computer networking devices 110/130.

In FIG. 4B, a computer networking device 110-1/130-1 may generate and transmit a tunneling capabilities message to the controller 140 (which may be an earlier generation controller 140-1) after discovery of the earlier generation controller 140-1 (communication 322 of FIG. 4B). The tunneling capabilities message may include a first tunnel type indicator and a second tunnel type indicator. In other words, as with FIG. 4A, the computer networking device 110-1/130-1 may support establishing and communicating via a plurality of different tunnel types. The earlier generation controller 140-1 may receive the tunneling capabilities message and select a tunnel type that is supported by the earlier generation controller 140-1 for full communication (e.g., the first tunnel type), and then the earlier generation controller 140-1 may generate and transmit to the computer networking device 110-1/130-1 a tunneling selection response message indicated the selected tunnel type (communication 324 of FIG. 4B). The computer networking device 110-1/130-1 may receive the tunneling selection response message, identify the first tunnel type selected by the earlier generation controller 140-1, and then generate and transmit a request to the controller 140 to establish a tunnel according to the first tunnel type (communication 326 of FIG. 4B). The earlier generation controller 140-1 and the computer networking device 110-1/130-1, in coordination with each other, may establish a tunnel according to the first tunnel type (communication 328 of FIG. 4B).

FIG. 4C is a communication diagram illustrating an example of generating and communicating a tunneling capabilities messages and selecting a default tunnel type when no response is received, according to some embodiments of the present disclosure. A scenario may arise in which the earlier generation controller 140-1 is not configured to receive and process tunneling capabilities messages transmitted by computer networking devices 110-1/130-1. For example, a computer networking device 110-1/130-1 may generate and transmit a tunneling capabilities message to the controller 140 (which may be an earlier generation controller 140-1) after discovery thereof (communication 332 of FIG. 4C). The tunneling capabilities message may include a first tunnel type indicator and a second tunnel type indicator. The earlier generation controller 140-1 may receive the tunneling capabilities message, but may not be configured to process the tunneling capabilities message, and the earlier generation controller 140-1 may not transmit a tunneling selection response message.

The computer networking device 110-1/130-1 may identify that no tunneling selection response message has been received. For example, the computer networking device 110-1/130-1 may instantiate a timer having a predetermined interval upon transmission of the tunneling capabilities message, and the timer may expire or elapse after the predetermined interval. On the basis that no tunneling selection response message has been received, the computer networking device 110-1/130-1 may identify the first tunnel type as a default tunnel type, and then generate and transmit a request to the controller 140 to establish a tunnel according to the first tunnel type (communication 336 of FIG. 4C). The earlier generation controller 140-1 and the computer networking device 110-1/130-1, in coordination with each other, may establish a tunnel according to the first tunnel type (communication 328 of FIG. 4C).

FIG. 5A is a block diagram illustrating example fields of a tunneling capabilities message 503. The fields of the tunneling capabilities message 503 may include one or more tunnel type identifiers 522. Although two tunnel type identifiers 522-1 and 522-2 are shown in FIG. 5A, it is to be understood that the present disclosure is not limited thereto, and in some embodiments there may be one or more than two tunnel type identifiers present in a given tunneling capabilities message 503.

In some embodiments, one or more tunnel type service identifiers 524 may be included for each tunnel type identifier 522 present in the tunneling capabilities message 503. For example, FIG. 5A shows four tunnel type service identifiers 524-1 to 524-4 are provided for the first tunnel type identifier 522-1, and four tunnel type service identifiers 524-5 to 524-8 are provided for the second tunnel type identifier 522-1, with the understanding that the present disclosure is not limited to the specific numbers of service identifiers of FIG. 5A, and that in some embodiments the number of service identifiers 524 provided for each tunnel type identifier 522 may be different.

Each tunnel type identifier 522 may identify a different tunnel protocol that is supported by the computer networking device 110/130 communicating the tunneling capabilities message 503. Each tunnel type service identifier 524 may identify a different protocol or messaging capability that the computer networking device 110/130 supported when an tunnel that is of the tunnel type 522 is established. In other words, when a first tunnel (e.g., a tunnel of the first tunnel type 522-1) is established, the computer networking device 110/130 may support or communicate via any one of the four first tunnel type service identifiers 524-1 to 524-4. When a second tunnel (e.g., a tunnel of the second tunnel type 522-2) is established, the computer networking device 110/130 may support or communicate via any one of the four second tunnel type service identifiers 524-5 to 524-8.

In some embodiments, the tunnel type identifier may identify both a tunnel protocol and a message protocol. For example, as discussed above, one example of a tunneling protocol may be the Websocket tunneling protocol. A tunnel type identifier 522 may further specify that messages transmitted via a tunnel established according to the tunnel type identifer are to be formatted according to the NATS messaging protocol. Stated differently, in some embodiments communication between the controller 140 and the computer networking devices 110/130 may operate according to a publish/subscribe (pub/sub) model. The controller 140 may be or may establish a pub/sub server and the one or more computer networking devices 110/130 may be or may establish pub/sub clients that register with or subscribe to the pub/sub server. The pub/sub model may allow messages to be broadcast to different parts of a system asynchronously. The pub/sub server may define message topics via which asynchronous event notifications may be broadcast. Message topics may share some similarity with endpoints. To broadcast a message, a component called a publisher may generate a message that identifies one or more related topics. The generated message may then be pushed to all subscribers of at least one of the related topic. The pub/sub clients may subscribe to various message topics, which allows the clients to send and receive messages related to those topics. The pub/sub server may be subscribed to all message topics, in some embodiments.

The present disclosure is not limited to specific tunneling protocols or specific messaging protocols of communications that are transmitted via established tunnels, but some examples are provided herein. In some embodiments, a supported tunnel type (i.e., a tunnel type identified by a tunnel type identifier 522-1) may be SSH, and some examples of messaging protocols or services that may be transmitted via an established SSH tunnel (i.e., some examples of services identified by service identifiers 524-1 to 524-4) may include SNMP, Syslog, HTTP, and Telnet. In some embodiments, a supported tunnel type (i.e., a tunnel type identified by a tunnel type identifier 522-2) may be Websocket or NATS-Websocket, and some examples of messaging protocols or services that may be transmitted via an established Websocket tunnel or NATS-Websocket (i.e., some examples of services identified by service identifiers 524-5 to 524-8) may include SNMP, Syslog, RESTCONF, and CLI. In some embodiments, as seen in the examples provided, communication via a particular message protocol may be supported over multiple tunnel protocols.

In particular, there is increasing interest in RESTCONF, as the format adheres to well-defined and publicized standards. In brief, RESTCONF is an interface that enables the configuration details of the computer networking device to be accessed via a RESTful HTTP interface, and uses well-known HTTP methods, such as GET, PUT, POST, DELETE, and so on to provide Create, Read, Update, Delete (CRUD) operations for the configuration details. RESTCONF is related to (but distinct from) NETCONF, and uses a specific modeling language called Yet Another Next Generation (YANG) to define various syntax and semantics of the configuration details and operations. In other words, configuration details for a computer networking device may be stored in an object that adheres to a YANG-defined model, and then those configuration details may be manipulated or modified using a RESTCONF interface. For example, a configuration data object or state (non-configuration) data object may be exposed as a resource that can be retrieved with the GET method. Resources representing configuration data can be modified with the DELETE, PATCH, POST, and PUT methods, for example using a modification data object. The configuration data, state data, and modification data may be encoded in either the eXtensible Markup Language (XML) or JavaScript Object Notation (JSON), two popular and well-defined formats. RESTCONF may provide more standardized interfaces, which are compatible with multi-vendor devices, reducing development and maintenance costs. RESTCONF may also provides high extensibility, allowing various vendors to define additional operations.

FIGS. 5B and 5C are block diagrams illustrating example fields of example tunneling selection response messages 505 and 507, according to some embodiments of the present disclosure. As seen in FIG. 5B, the response message 505 may include the second tunnel type identifier 522-2 and optionally, may include one or more of the tunnel type service identifiers 524 associated with the second tunnel type identifier 522-2 (e.g., a first of the service type identifiers 524-5 associated with the second tunnel type identifier 522-2). As seen in FIG. 5C, the tunneling selection response message 507 may include the first tunnel type identifier 522-1 and optionally, may include one or more of the tunnel type service identifiers 524 associated with the first tunnel type identifier 522-1 (e.g., a third of the service type identifiers 524-3 associated with the first tunnel type identifier 522-1).

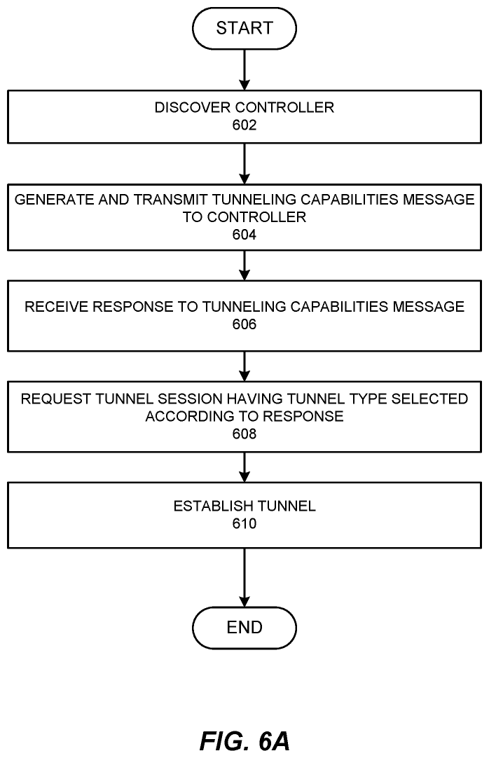

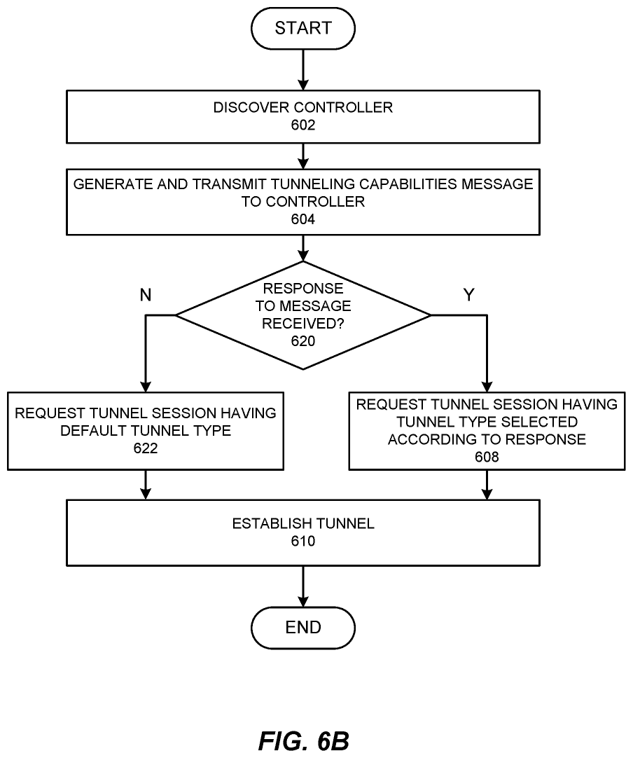

FIGS. 6A and 6B are flow diagrams of generating and transmitting a tunneling capabilities message and establishing a tunnel based on the response (or lack thereof) to the tunneling capabilities message, according to some embodiments of the present disclosure.

In FIG. 6A, a computer networking device 110-1/130-1 may discover the network address of a controller 140-1 (block 602). As discussed above, a variety of techniques may be used to advertise the network address of the controller 140-1 to the first computer networking device 110-1/130-1. For example, the address of the controller 140-1 may be advertised by configuring the network, such as by registering the controller with a domain name server (DNS) or configuring the Dynamic Host Control Protocol (DHCP) server, or by registering the controller 140-1 with a device registration service that can be contacted for the network address of the controller 140-1.

The computer networking device 110-1/130-1 may generate and transmit a tunneling capabilities message to the controller 140-1 after discovery of the controller 140-1 (block 604). The tunneling capabilities message may include a first tunnel type indicator and a second tunnel type indicator. In other words, the computer networking device 110-1/130-1 may support establishing and communicating via a plurality of different tunnel types. The computer networking device 110-1/130-1 may receive a tunneling selection response message from the controller 140-1 (block 606), identify a tunnel type that selected by the controller 140-1, and then generate and transmit a request to the controller 140-1 to establish a tunnel according to the selected tunnel type (block 608). The computer networking device 110-1/130-1, in coordination with the controller 140-1, may establish a tunnel according to the selected tunnel type (block 610).

In FIG. 6B, a computer networking device 110-1/130-1 may discover the network address of a controller 140-1 (block 602, with reference made to the discussion of block 602 of FIG. 6A), and then generate and transmit a tunneling capabilities message to the controller 140-1 after discovery of the controller 140-1 (block 604, with reference made to the discussion of block 604 of FIG. 6A). The computer networking device 110-1/130-1 may identify whether a response to the tunneling capabilities message is received (e.g., received within a predetermined time interval) (block 620). If a tunneling selection response message from the controller 140-1 is received (“Y” branch from block 620), the computer networking device 110-1/130-1 may identify a tunnel type that is selected by the controller 140-1, and then generate and transmit a request to the controller 140-1 to establish a tunnel according to the selected tunnel type (block 608). The computer networking device 110-1/130-1, in coordination with the controller 140-1, may establish a tunnel according to the selected tunnel type (block 610). On the other hand, if a tunneling selection response message from the controller 140-1 is not received (“N” branch from block 620), the computer networking device 110-1/130-1 may identify a default tunnel type, and then generate and transmit a request to the controller 140-1 to establish a tunnel according to the default tunnel type (block 622). The computer networking device 110-1/130-1, in coordination with the controller 140-1, may establish a tunnel according to the default tunnel type (block 610).

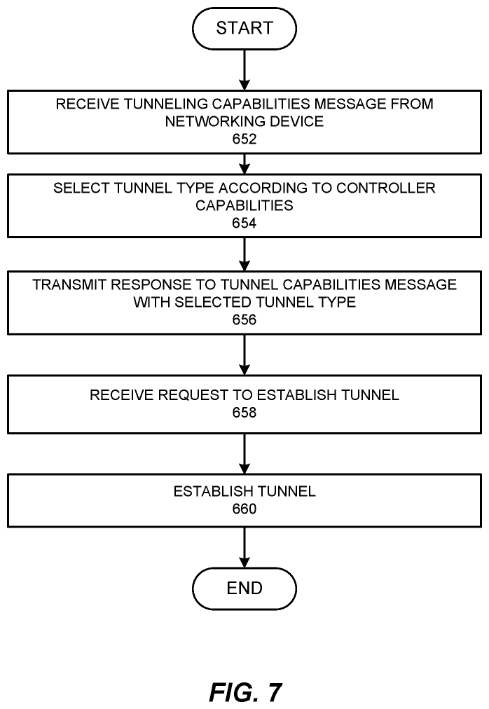

FIG. 7 is a flow diagram of receiving a tunneling capabilities message, selecting a tunneling type, generating and transmitting a response indicating the selected tunneling type, and establishing a tunnel based on selected tunneling type, according to some embodiments of the present disclosure.

In FIG. 7, a controller 140 may receive a tunneling capabilities message from a computer networking device 110/130 (block 652). As discussed above, in some embodiments, the tunneling capabilities message may include a plurality of tunnel type indicators (e.g., at least a first tunnel type indicator and a second tunnel type indicator) indicating tunnel types that are supported by the computer networking device 110/130 for establishing secure communication tunnels. The controller 140 may select from the plurality of tunnel type indicators an indicator corresponding to a tunnel type that is supported by the controller for full communication (block 654), and the controller may generate and transmit to the computer networking device 110-1/130-1 a tunneling selection response message that includes the selected tunnel type indicator (block 656). The controller 140 may then receive a request from the computer networking device 110/130 to establish a tunnel according to the selected tunnel type (block 658). The controller 140 may coordinate with the computer networking device 110-1/130-1 to establish a tunnel according to the selected tunnel type (block 660).

Among the benefits of the inventive concepts of the present disclosure, only some of which are discussed herein, include a benefit that the manufacturer and vendor of computer networking equipment may provide an upgrade and downgrade path for a controller that is somewhat decoupled from the upgrade and downgrade path for computer networking devices (e.g., switches and access points) that are controlled by the controller. For example, the manufacturer and vendor may avoid the need to invest resources in preparing an upgrade to earlier generation controllers to use a different tunnel type than is presently supported, and instead prepare a significantly smaller update to such controllers to receive and process the tunneling capabilities messages discussed above. Another example of a benefit provided by the inventive concepts includes better handling of scenarios in which a computer networking device is upgraded but may still need to connect and communicate with an earlier generation controller, at least on a temporary basis. By better facilitating such connections and communications, the inventive concepts of the present disclosure thereby improve the functioning of the computer networking devices, the controller, and/or the network or system that includes such devices.

FIG. 8 is a block diagram illustrating an electronic device 1100 in accordance with some embodiments. The electronic device 1100 may be, for example, one of the access points 110 or one of the client devices 120 illustrated in FIG. 1, the network switches 130 illustrated in FIGS. 1 and 3, the controller 140 of FIGS. 1 and 3, the remote device 152 of FIG. 1, and other devices. The electronic device 1100 includes a processing subsystem 1110, a memory subsystem 1112, and a networking subsystem 1114. Processing subsystem 1110 includes one or more devices configured to perform computational operations. Memory subsystem 1112 includes one or more devices for storing data and/or instructions. In some embodiments, the instructions may include an operating system and one or more program modules which may be executed by processing subsystem 1110.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). While FIG. 8 includes an antenna 1120, in some embodiments electronic device 1100 includes one or more nodes, such as nodes 1108, e.g., a connector, which can be coupled to one or more antennas 1120 that are external to the electronic device 1100. Thus, electronic device 1100 may or may not include the one or more antennas 1120. Networking subsystem 1114 includes at least a networking system based on the standards described in IEEE 802.11 (e.g., a Wi-Fi networking system).

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 may use the mechanisms in networking subsystem 1114 for performing simple wireless communication between the electronic devices, e.g., transmitting frames and/or scanning for frames transmitted by other electronic devices.

Processing subsystem 1110, memory subsystem 1112, and networking subsystem 1114 are coupled together using bus 1128. Bus 1128 may include an electrical, optical, and/or electro-optical connection that the subsystems can use to communicate commands and data among one another.

Electronic device 1100 can be (or can be included in) any electronic device with at least one network interface. For example, electronic device 1100 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

The operations performed in the communication techniques according to embodiments of the present disclosure may be implemented in hardware or software, and in a wide variety of configurations and architectures. For example, at least some of the operations in the communication techniques may be implemented using program instructions 1122, operating system 1124 (such as a driver for interface circuit 1118) or in firmware in interface circuit 1118. Alternatively or additionally, at least some of the operations in the communication techniques may be implemented in a physical layer, such as hardware in interface circuit 1118.

Embodiments of the present disclosure have been described above with reference to the accompanying drawings, in which embodiments of the disclosure are shown. The inventive concepts may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed is:

1. A method comprising:
generating, by a computer networking device, a tunneling capabilities message indicating a plurality of different tunnel types supported by the computer networking device;
transmitting the tunneling capabilities message to a controller;
receiving, from the controller, a tunneling selection response message indicating one tunnel type of the plurality of different tunnel types;
requesting, by the computer networking device, establishment of a tunnel of the one tunnel type indicated by the tunneling selection response message; and
establishing the tunnel of the one tunnel type between the computer networking device and the controller.

2. The method of claim 1, wherein the plurality of different tunnel types includes a secure shell (SSH) tunnel type.

3. The method of claim 1, wherein the plurality of different tunnel types includes a Websocket tunnel type.

4. The method of claim 1, wherein the tunneling capabilities message further includes, for each of the plurality of different tunnel types, at least one tunnel type service identifier indicating a service or protocol for messages to be communicated via the corresponding tunnel type.

5. The method of claim 4, wherein one of the tunnel type service identifiers indicates a RESTCONF protocol.

6. The method of claim 1, further comprising discovering a network address of the controller prior to transmitting the tunneling capabilities message.

7. The method of claim 1, wherein the computer networking device is a networking switch.

8. The method of claim 1, wherein the computer networking device is a wireless access point.

9. The method of claim 1, wherein the one tunnel type indicated by the tunneling selection response message is a tunnel type supported by the controller for normal communication, the controller supporting a second tunnel type for limited communication.

10. A method comprising:
receiving, by a controller, a tunneling capabilities message indicating a plurality of tunnel types that are supported by a computer networking device;
selecting, by the controller, one of the tunnel types from the plurality of tunnel types indicated by the tunneling capabilities message;
transmitting a tunneling selection response message to the computer networking device indicating the selected tunnel type;
receiving, by the controller, a request to establish a tunnel of the selected tunnel type; and
establishing a tunnel of the selected tunnel type between the computer networking device and the controller.

11. The method of claim 10, wherein the plurality of tunnel types includes a secure shell (SSH) tunnel type.

12. The method of claim 10, wherein the plurality of tunnel types includes a Websocket tunnel type.

13. The method of claim 10, wherein the tunneling capabilities message further includes, for each of the plurality of tunnel types, at least one tunnel type service identifier indicating a service or protocol for messages to be communicated via the corresponding tunnel type.

14. The method of claim 13, wherein one of the tunnel type service identifiers indicates a RESTCONF protocol.

15. The method of claim 10, wherein the computer networking device is a networking switch.

16. The method of claim 10, wherein the computer networking device is a wireless access point.

17. A method comprising:
generating, by a computer networking device, a tunneling capabilities message indicating a plurality of different tunnel types supported by the computer networking device;
transmitting the tunneling capabilities message to a controller;
identifying that a tunneling selection response message from the controller has not been received after a predetermined time interval has elapsed;
requesting, by the computer networking device, establishment of a tunnel of a default tunnel type of the plurality of different tunnel types; and
establishing the tunnel of the default tunnel type between the computer networking device and the controller.

18. The method of claim 17, wherein the plurality of different tunnel types includes a secure shell (SSH) tunnel type and a Websocket tunnel type.

19. The method of claim 18, wherein the computer networking device is a networking switch.

20. The method of claim 17, wherein the computer networking device is a networking switch.
